(19) United States
(12) Patent Application Publication
(10) Pub. No.: US 2021/0127184 A1
(43) Pub. Date: Apr. 29, 2021

(54) BONE CONDUCTION SPEAKER UNIT

(71) Applicant: TEMCO JAPAN CO., LTD., TOKYO (JP)

(72) Inventor: MIKIO FUKUDA, TOKYO (JP)

(21) Appl. No.: 16/493,881

(22) PCT Filed: Dec. 17, 2018
(86) PCT No.: PCT/JP2018/046383

§ 371 Date: Sep. 13, 2019

(30) Foreign Application Priority Data
Dec. 28, 2017 (JP) 2017-254539

(51) Int. Cl. H04R 1/02

(52) U.S. Cl. CPC H04R 1/02; H04R 2499/11

(57) ABSTRACT

Provided is a bone conduction speaker unit with which, in order to improve the vibration characteristics, a vibration-suppressing structure is incorporated in a unit main body, whereby sound leakage and vibration from the unit as a single body can be suppressed. The bone conduction speaker unit, including a bone conduction speaker main body incorporated in a casing, uses a flat plate spring for holding the bone conduction speaker main body in the casing, the flat plate spring being disposed such that the direction of vibration of the bone conduction speaker main body being in parallel with the direction of vibration of the flat plate spring.

### CROSS-REFERENCE TO RELATED APPLICATIONS

This application claims priority to PCT Application No. PCT/JP2018/046383, having a filing date of Dec. 17, 2018, based off of Japanese Application No. 2017-254539, having a filing date of Dec. 28, 2017, the entire contents of which are hereby incorporated by reference.

### FIELD OF TECHNOLOGY

The following relates to a bone conduction speaker unit, and more particularly, to a bone conduction speaker unit that, upon being incorporated in a mobile phone, or the like, will not present a problem of sound leakage.

### BACKGROUND

The bone conduction speaker unit converts a voice signal into a vibration to transmit it to the skull, and the like, being compact and lightweight and capable of being used even under noise, whereby, in recent years, it has been widely used with communication apparatuses, such as a mobile phone, and the like.

In case where this bone conduction speaker unit is incorporated in a handset of telephone, there is a possibility that the vibration of a speaker part of the bone conduction speaker unit may cause the housing of the handset to be vibrated, resulting in occurrence of a sound leakage, and a vibrational output sneaking to a microphone, tending to cause howling. In order to eliminate such problems, it is necessary that the bone conduction speaker unit and the handset main body (housing) be isolated from each other.

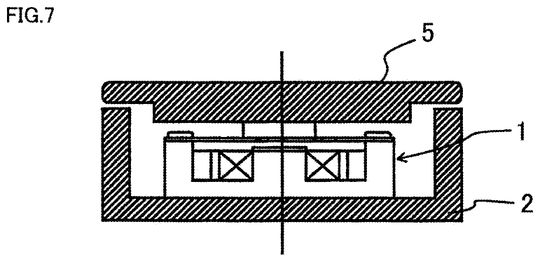

General bone conduction speaker units has a structure with which a bone conduction speaker unit of magnetic type is fixed in a small-sized casing (see FIG. 7). Since the bone conduction speaker unit of such a type has a structure that causes the casing to be vibrated as a whole, it is required that, when the bone conduction speaker unit is incorporated into the handset main body, an appropriate elastic base be interposed between the unit and the main body to absorb the vibration of the speaker, and otherwise, the main body is vibrated, resulting in the so-called leakage sound being increased, which is a drawback of the bone conduction speaker unit of this type. In addition, the larger the size of the speaker unit, the higher the air conduction sound (sound leakage) from the speaker unit itself will be.

### SUMMARY

In order to solve such problems, the applicant of the present application has previously proposed a configuration of a bone conduction speaker unit that, at the time of non-calling, can prevent generation of sound leakage and, at the time of calling, can exert the performance comparable to that of a conventional bone conduction speaker, wherein the configuration includes an accommodating section made of an elastic material, enclosing and supporting the entire bone conduction speaker, and a movable top face covering the top of the accommodating section and being disposed in contact with a diaphragm of the bone conduction speaker so as to be vibrated therewith, the movable top face having a projection formed on the inner face thereof, and at the time when the communication apparatus is not in use, only the projection being in contact with a plate yoke fixed to the diaphragm (refer to Patent Literature 1: Japanese Patent Publication No. 4369976).

However, the configuration according to this proposal gives a disadvantage that, although the vibration in the medium and high areas can be transmitted with no problem at the time of use in the vibration-absorbable range, the vibration in the low area is absorbed by the elastic base, being attenuated, thereby the low-area characteristics being not be able to be sufficiently secured. In such a case, if the speaker unit is heavily pressed against the human body in order to cover the low area characteristics, the vibration will not be absorbed by the elastic base portion, resulting in the vibration being transmitted to the main body, and thus the sound leakage is increased.

Further, the applicant of the present application has proposed a bone conduction speaker unit, wherein a bone conduction speaker main body is disposed in a casing with an elastic base being interposed; an elastic plate is fixed on a top face of a plate yoke of the bone conduction speaker main body; and a contact is provided on an inner top face of an elastic cover, and wherein, upon the elastic cover being loaded on the casing, a gap is held between a bottom face of the contact and the top face of the plate yoke of the bone conduction speaker main body, and upon a pressing force having been applied to the elastic cover in use, the bottom face of the contact is abutted against the elastic plate on the top face of the plate yoke (refer to Patent Document 2: WO2014/083986).

However, with this bone conduction speaker unit, at the time of non-use, when no pressing force is applied to the elastic cover, a gap is always held between the bottom face of the contact and the top face of the elastic plate, or between the bottom of a larger thickness portion of the elastic cover and the top face of the plate yoke, whereby it is positively prevented that a vibration is inadvertently transmitted to the elastic cover to generate a voice vibration, resulting in occurrence of a sound leakage, and thus it could be the that such bone conduction speaker unit is not intended for improving the vibration characteristics.

As described above, with mobile phones, and the like, which use a conventional bone conduction speaker, the contact is always in tight contact with the plate yoke, thereby, even at the time of non-calling, when the contact is not abutted against a side face of the head, the contact being vibrated to generate a voice vibration, resulting in occurrence of a sound leakage, which has been a problem. And, there have been proposed various ideas for solving this problem, however, the bone conduction speakers that have been proposed up to now are not intended to solve the problem of sound leakage by improving the vibration characteristics.

Then, embodiments of the present invention have been made to provide a bone conduction speaker unit with which a vibration isolation structure is incorporated in the speaker unit main body for improving the vibration characteristics, whereby the sound leakage from the unit as a single body can be suppressed.

Particularly, as aspects of the present invention, there are provided the following:

A bone conduction speaker unit, including:

a bone conduction speaker main body that is incorporated in a casing,

as a means for holding the bone conduction speaker main body in the casing, a flat plate spring being used,

the flat plate spring being disposed such that the direction of vibration of the bone conduction speaker main body being in parallel with the direction of vibration of the flat plate spring.

In one embodiment, the bone conduction speaker main body is disposed on the flat plate spring through a weight that is attached to a yoke part of the bone conduction speaker main body.

In another embodiment, the bone conduction speaker main body is accommodated in an inner casing, and is disposed on the flat plate spring through a weight that is attached to a back face of a bottom part of the inner casing.

In still another embodiment, the bone conduction speaker main body is suspended with a diaphragm thereof being fixed to a back face of the flat plate spring through a plate yoke.

In one embodiment, the flat plate spring is comprised of a peripheral part that is fixed to the casing, and a spring plate that is communicated to the inner side of the peripheral part through a connecting part that is provided at a plurality of places in the peripheral part.

Embodiments of the invention are as described above, and since the bone conduction speaker main body in accordance therewith is held in the casing through the flat plate spring alone, the vibration output thereof is transmitted directly to the human body, while being transmitted to the casing through the flat plate spring, thereby there being provided an effect that, by selecting the spring constant for the flat plate spring, it is made possible to suppress the vibration leakage to the casing.

### BRIEF DESCRIPTION

Some of the embodiments will be described in detail, with reference to the following figures, wherein like designations denote like members, wherein:

FIG. 1 is a longitudinal sectional view of a bone conduction speaker unit in accordance with one embodiment of the present invention;

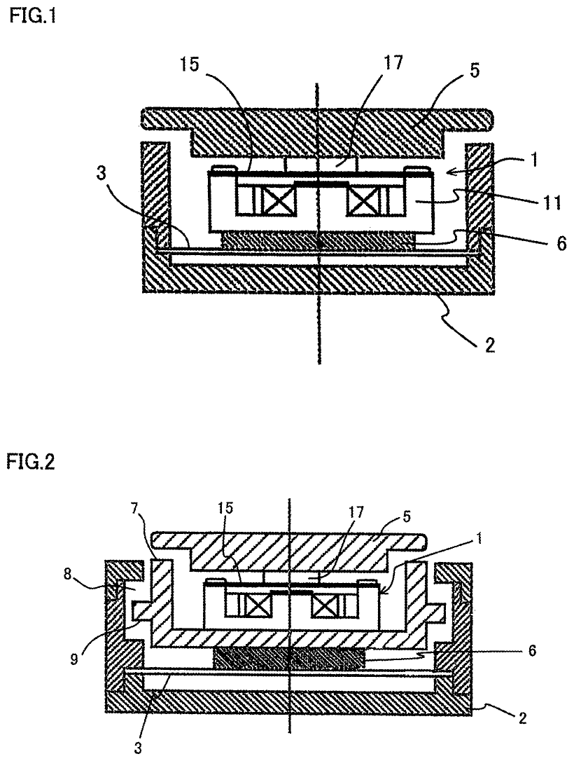

FIG. 2 is a longitudinal sectional view of a bone conduction speaker unit in accordance with another embodiment of the present invention;

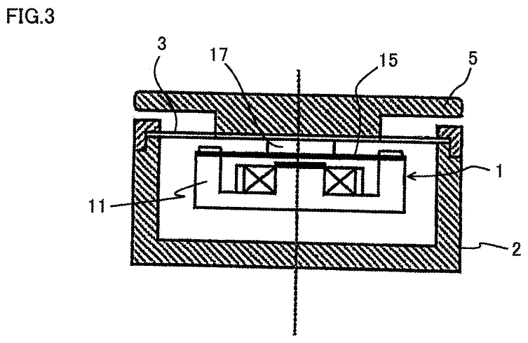

FIG. 3 is a longitudinal sectional view of a bone conduction speaker unit in accordance with still another embodiment of the present invention;

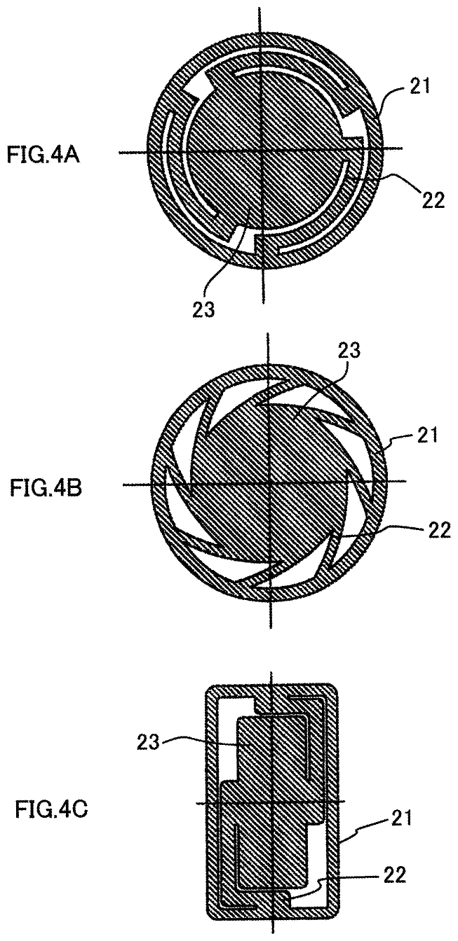

FIG. 4A gives an example of geometry of the flat plate spring to be used with a bone conduction speaker unit in accordance with embodiments of the present invention;

FIG. 4B gives another example of geometry of the flat plate spring to be used with a bone conduction speaker unit in accordance with embodiments of the present invention;

FIG. 4C gives still another example of geometry of the flat plate spring to be used with a bone conduction speaker unit in accordance with embodiments of the present invention;

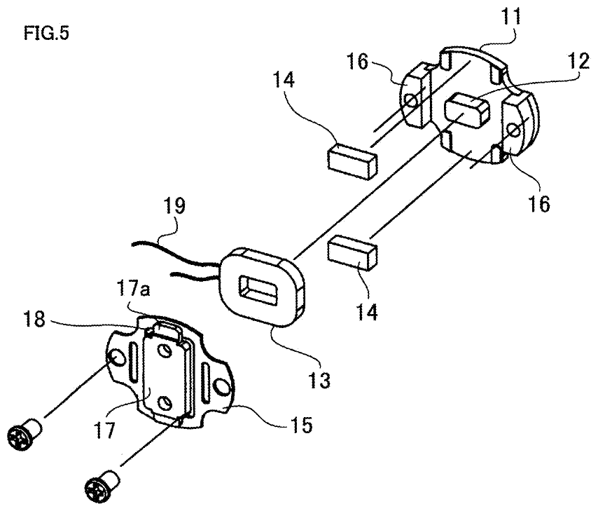

FIG. 5 is an exploded perspective view of a bone conduction speaker main body of the bone conduction speaker unit in accordance with embodiments of the present invention;

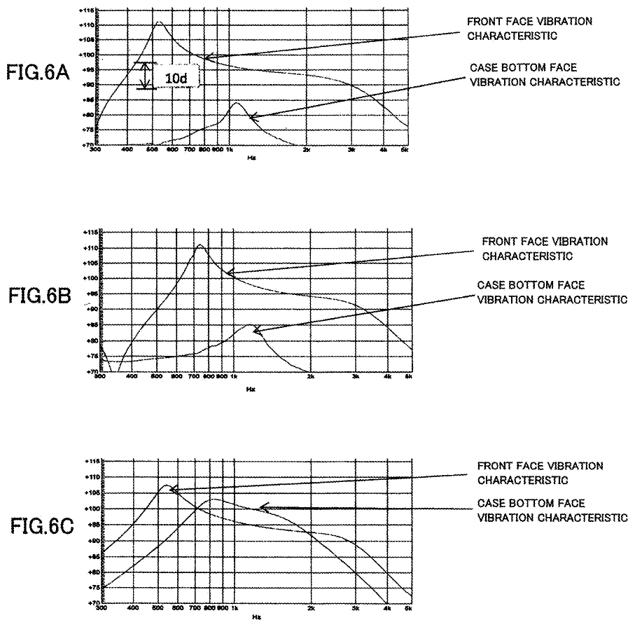

FIG. 6A gives a graph of vibration characteristics showing the effectiveness of the bone conduction speaker unit in accordance with embodiments of the present invention;

FIG. 6B gives a graph of vibration characteristics in case where a weight is removed from the bone conduction speaker unit in accordance with embodiments of the present invention;

FIG. 6C gives a graph of vibration characteristics for a conventional bone conduction speaker unit, in which the yoke is fixed to an inner bottom face of the casing; and

FIG. 7 is a longitudinal sectional view giving an example of configuration of conventional bone conduction speaker units.

### DETAILED DESCRIPTION

Hereinbelow, embodiments of the present invention will be explained with reference to the accompanying drawings. As shown in FIG. 1, the bone conduction speaker unit in accordance with embodiments of the present invention is a bone conduction speaker unit with which a bone conduction speaker main body 1 is incorporated in a casing 2, featuring that, as a means for fixing the bone conduction speaker main body 1 to the casing 2, a flat plate spring 3 is used, the flat plate spring 3 being disposed such that the direction of vibration of the bone conduction speaker main body 1 is in parallel with that of the flat plate spring 3. The casing 2 provides an accommodating element made of rigid plastic in general.

As shown in FIG. 5, for example, with the bone conduction speaker main body 1, a voice coil 13 is disposed so as to surround a center pole 12 provided in the central portion of a yoke 11, with a pair of bar-like magnets 14, 14 being attached to both sides of the voice coil 13, and a diaphragm 15 being disposed so as to cover the voice coil 13 and the magnets 14, 14. Both end parts of the diaphragm 15 are fixed by screws to the top face of side walls 16 that are erected on both end parts of the yoke 11. At that time, a gap is provided between the diaphragm 15 and the top face of the voice coil 13.

In the diaphragm 15, an opening 18, which corresponds to a plate yoke 17, is formed, and with both end parts 17a in a longitudinal direction of the plate yoke 17 that extend beyond the opening 18 being fixed to the edge parts of the opening 18, the plate yoke 17 is disposed so as to block the opening 18. Thus, the plate yoke 17 is vibrated along with the vibration of the diaphragm 15. The above configuration provides a so-called outer shell one, in which the magnets 14, 14 are disposed outside of the voice coil 13, however, contrarily to such configuration, a so-called inner shell configuration, in which the magnet (also serving as the center pole) is disposed inside the voice coil, may be provided. Lead wires 19 extending from the voice coil 13 are pulled out from an opening that is provided in the side wall of the casing 2.

The bone conduction speaker main body 1 is provided with a contact 5 that is butted against an ear or a peripheral portion thereof when in use. Needless to say, the contact 5 is disposed such that it is located slightly above the casing 2. The bone conduction speaker main body 1 in a first embodiment, which is illustrated in FIG. 1, is disposed on the flat plate spring 3 through a weight 6 attached to the back face of the yoke 11 thereof. The heavier the weight 6, the larger the vibration suppressing effect thereof will be, however, the weight 6 is generally specified to be as heavy as approx. two times the weight of the bone conduction speaker main body 1. The contact 5 for transmitting a vibration to a human body is disposed on the diaphragm 15 of the bone conduction speaker main body 1 through the plate yoke 17.

In the first embodiment, the purpose for disposing the weight 6 on the bone conduction speaker main body 1 is to improve the frequency characteristics. In other words, if the bone conduction speaker main body 1 of a general size is fixed to the casing 2 through the flat plate spring 3, because the weight thereof as a single body is so light that the resonance point (f₀) in the low area of the front face vibration characteristic, which is determined by the weight of the bone conduction speaker main body 1 and the spring constant of the flat plate spring 3, becomes undesirably high, the weight 6 is attached to the yoke 11 in order to improve the frequency characteristics.

FIG. 6A to FIG. 6C give data for the vibration characteristics, and FIG. 6A gives data on a bone conduction speaker unit having a structure provided with the weight 6 as shown in FIG. 1, while FIG. 6B giving data on a bone conduction speaker unit having the same structure as shown in FIG. 1, except that the weight 6 is not provided therefor.

As is obvious from comparison of the data on one of these two bone conduction speaker units with that on the other, the bone conduction speaker unit provided with the weight 6 shows a lower resonance point (f₀) in the low area of the front face vibration characteristic, and therefore, it can be the that the structure that is provided with the weight 6 as shown in FIG. 6 is more desirable. However, even with the structure with which the weight 6 is not used, the vibration suppressing effect will not be heavily deteriorated, although the front face frequency characteristic becomes unsatisfactory, and thus the structure which is not provided with the weight 6 has a sufficient practicability, in such a case as sound transmission, where the sound quality is not emphasized.

FIG. 6C gives measurement data on a conventional bone conduction speaker unit, in which the yoke 11 is fixed to an inner bottom face of the casing 2 (see FIG. 7), and with such a type of bone conduction speaker unit, the sound vibration is transmitted to the casing 2 without being suppressed, thereby the casing 2 and a mobile phone in which it is incorporated, or the like, will be greatly vibrated, resulting in a large amount of sound leakage.

The flat plate spring 3 for use in the bone conduction speaker unit in accordance with embodiments of the present invention is comprised of a peripheral part 21, which is fixed to the casing 2, and a flat plate spring 23, which is communicated with the inner side of the peripheral part 21 through a long and narrow connecting part 22, which is provided at a plurality of places in the peripheral part 21, the bone conduction speaker main body 1 being fixed onto the flat plate spring 23 through the weight 6.

The flat plate spring 3 may be formed in a desired shape according to the geometry of the casing 2. FIG. 4A to FIG. 4C give examples of the shape, FIG. 4A and FIG. 4B giving a circular shape, while FIG. 4C a rectangular shape. More particularly, in the example as given in FIG. 4A, the connecting part 22 has a circular arc shape, being provided along the peripheral part 21 in three places; in the example as given in FIG. 4B, the connecting part 22 has a spiral shape, being provided in eight places; and in the example as given in FIG. 4C, the connecting part 22 has a letter-L shape, being provided in two places. With any of these flat plate springs 3, the spring plate 23 is separated from the peripheral part 21, being connected to the peripheral part 21 by the long and narrow connecting part 22, whereby there is provided a configuration that is sensitive to a vibration.

The advantages that are provided by using the flat plate spring 3 having any one of the above configurations in order to absorb vibrations are as follows:
Since the vibration absorbing member is a plate spring that is thin and planer, the overall height of the unit can be held to a low one, as compared to any other configurations, whereby the space required for installation can be minimized.
The direction of vibration for the flat plate spring 3 is practically limited to vertical one, thereby the unnecessary vibration in a longitudinal direction being suppressed. Also, for vibration in a vertical direction, the amplitude is held to a minimum, resulting from the structure of the flat plate spring 3, and thus as compared to any other vibration absorbing means, an over-amplitude at the time of an excessive input is difficult to be caused.
Since the flat plate spring 3 is made of a metal, it is excellent in heat resistance and weatherability, exhibiting little change in the lapse of time, and being capable of maintaining a stable performance of vibration absorption.
The flat plate spring 3 is sensitive to a vibration, being effective to provide the unit with a sufficiently low value for the resonant frequency mainly in the low area, and a high ability of absorbing vibrations.

In a second embodiment, which is illustrated in FIG. 2, the bone conduction speaker main body 1 is accommodated in an inner casing 7, the contact 5 being separated from the top face thereof, and in such state, being incorporated in the casing 2. And to the back face of the inner casing 7, the weight 6 is attached, and the weight 6 is fixed onto the spring plate 23 of the flat plate spring 3. A peripheral groove 8 is formed in the inner side face of the casing 2, and in the outer side face of the inner casing 7, an outer peripheral flange 9, which is vertically moved in a non-contact manner at the time of the bone conduction speaker main body 1 being driven.

In a third embodiment, which is illustrated in FIG. 3, the bone conduction speaker main body 1 is suspended with the diaphragm 15 being fixed to the back face of the flat plate spring 3 through the plate yoke 17.

With the bone conduction speaker unit in accordance with the embodiments 1 and 2 of the present invention, at the time of non-calling, when a pressing force is not applied to the contact 5, the synergism of the weight 3 and the flat plate spring 3 provides a vibration suppressing effect, whereby generation of an unintended occurrence of sound leakage can be avoided.

The maximum feature of the bone conduction speaker unit in accordance with embodiments of the present invention resides in that it is provided with a structure with which a sound output generated in the bone conduction speaker main body 1 is always transmitted to the casing 2 through the flat plate spring 3, which holds the bone conduction speaker main body 1. Some of the bone conduction speakers of dynamic type have a configuration that uses a plate spring, however, such plate spring is used for increasing the bone conduction output by utilizing the resonance in the low frequency area, and is not used for vibration suppressing as with the bone conduction speaker unit in accordance with embodiments of the present invention.

With the bone conduction speaker unit in accordance with embodiments of the present invention, since the bone conduction speaker main body 1 is held in the casing 2 through the flat plate spring 3 alone, the vibration output thereof is transmitted directly to the human body, while being transmitted to the casing 2 through the flat plate spring 3, thereby an effect being provided that, by selecting the spring constant for the flat plate spring 3, it is made possible to suppress the vibration leakage to the casing 2. In addition, the bone conduction speaker unit in accordance with embodiments of the present invention is completed as an independent unit with which sound leakage is suppressed to a minimum, and therefore it offers an advantage that it can be used, being incorporated as it is in the main body casing of a mobile phone, or the like, by an optional mounting method, thereby providing a great industrial applicability.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A bone conduction speaker unit, comprising:
a bone conduction speaker main body that is incorporated in a casing,
a holder for the bone conduction speaker main body in the casing, a flat plate spring being used,
the flat plate spring being disposed such that the direction of vibration of the bone conduction speaker main body being in parallel with the direction of vibration of the flat plate spring.

2. The bone conduction speaker unit according to claim 1, wherein the bone conduction speaker main body is disposed on flat plate spring through a weight that is attached to a yoke part of the bone conduction speaker main body.

3. The bone conduction speaker unit according to claim 1, wherein the bone conduction speaker main body is accommodated in an inner casing, the inner casing being disposed on the flat plate spring through a weight that is attached to a back face of a bottom part of the inner casing.

4. The bone conduction speaker unit according to claim 1, wherein the bone conduction speaker main body is suspended with a diaphragm thereof being fixed to a back face of the flat plate spring through a plate yoke.

5. The bone conduction speaker unit according to claim 1, wherein the flat plate spring is comprised of a peripheral part that is fixed to the casing, and a spring plate that is communicated to the inner side of the peripheral part through a connecting part that is provided at a plurality of places in the peripheral part.
